(19) United States
(12) Patent Application Publication
(10) Pub. No.: US 2023/0394830 A1
(43) Pub. Date: Dec. 7, 2023

(54) IMAGE PROCESSING APPARATUS, IMAGE PROCESSING METHOD, AND NON-TRANSITORY STORAGE MEDIUM

(71) Applicant: NEC Corporation, Tokyo (JP)

(72) Inventor: Naruki KANNO, Tokyo (JP)

(73) Assignee: NEC Corporation, Tokyo (JP)

(21) Appl. No.: 18/202,713

(22) Filed: May 26, 2023

(30) Foreign Application Priority Data
Jun. 2, 2022 (JP) 2022-090090

(51) Int. Cl. G06V 20/52; G06T 7/292; G06T 7/62; G06V 40/20

(52) U.S. Cl. CPC G06V 20/52; G06T 7/292; G06T 7/62; G06V 40/20

(57) ABSTRACT

The present invention provides an image processing apparatus 10 including an acquisition unit 11 that acquires a plurality of camera images photographed by a plurality of cameras installed within a facility, a camera image determination unit 12 that determines, based on at least one of weather information on a day, schedule information of each surveillance target person on the day, and a behavior tendency of each surveillance target person within a facility, a camera image for which each of surveillance target persons is searched from among a plurality of camera images, and a search unit 13 that searches for each of surveillance target persons from among each of the camera images being determined as a target for which each of surveillance target persons is searched.

This application is based upon and claims the benefit of priority from Japanese patent application No. 2022-90090, filed on Jun. 2, 2022, the disclosure of which is incorporated herein in its entirety by reference.

### TECHNICAL FIELD

The present invention relates to an image processing apparatus, an image processing method, and a program.

### BACKGROUND ART

A technique associated with the present invention is disclosed in Japanese Patent Application Publication No. 2019-23876, Japanese Patent Application Publication No. 2016-52013, Japanese Patent Application Publication No. 2018-163700, and Japanese Patent Application Publication No. 2002-26904.

Japanese Patent Application Publication No. 2019-23876 discloses an image management system in which a specific subject is extracted from among a photographed image, based on a master image being registered in advance, and some pieces of work of a nursery teacher are performed based on a result of the extraction.

Japanese Patent Application Publication No. 2016-52013, and Japanese Patent Application Publication No. 2018-163700 disclose an image processing apparatus that extracts a still image of a best shot from among a moving image.

Japanese Patent Application Publication No. 2002-26904 discloses a technique for distributing, to each family, a moving image of a child photographed within a facility such as a nursery school in real time.

### DISCLOSURE OF THE INVENTION

It is possible to improve quality of various services relating to a surveillance target person by photographing inside a facility by a plurality of surveillance cameras, searching for the surveillance target person within an image, and performing various pieces of processing. For example, the facility is a kindergarten, a nursery school, or the like, the surveillance target person is a kindergarten child or a nursery school child, and the various services are behavior observation and the like.

By increasing the number of surveillance cameras to be installed, it is possible to thoroughly photograph within a facility, and thoroughly search for a surveillance target person. However, as the number of surveillance cameras increases, the number of images to be generated increases, and a processing load on a computer that performs an image analysis increases.

Japanese Patent Application Publication No. 2019-23876 discloses a technique in which a specific subject is extracted from among a photographed image, and some pieces of work of a nursery teacher are performed based on a result of the extraction, but does not disclose the above-described problem and a solving means for the problem.

Japanese Patent Application Publication No. 2016-52013, and Japanese Patent Application Publication No. 2018-163700 disclose a technique for extracting a still image of a best shot from among a moving image, but do not disclose the above-described problem and a solving means for the problem.

Japanese Patent Application Publication No. 2002-26904 discloses a technique for distributing, to each family, a moving image of a child photographed within a facility such as a nursery school in real time, but does not disclose the above-described problem and a solving means for the problem.

In view of the above-described problem, one example of an object of the present invention is to provide an image processing apparatus, an image processing method, and a program that achieve a task of reducing a load on a computer in processing of searching for each of a plurality of surveillance target persons from among a plurality of images photographed by a plurality of cameras installed within a facility.

One aspect of the present invention provides an image processing apparatus including:
an acquisition unit that acquires a plurality of camera images photographed by a plurality of cameras installed within a facility;
a camera image determination unit that determines, based on at least one of weather information on a day, schedule information of each surveillance target person on the day, and a behavior tendency of each surveillance target person within a facility, the camera image for which each of the surveillance target persons is searched from among a plurality of the camera images; and
a search unit that searches for each of the surveillance target persons from among each of the camera images being determined as a target for which each of the surveillance target persons is searched.

One aspect of the present invention provides an image processing method including, by a computer:
acquiring a plurality of camera images photographed by a plurality of cameras installed within a facility;
determining, based on at least one of weather information on a day, schedule information of each surveillance target person on the day, and a behavior tendency of each surveillance target person within a facility, the camera image for which each of the surveillance target persons is searched from among a plurality of the camera images; and
searching for each of the surveillance target persons from among each of the camera images being determined as a target for which each of the surveillance target persons is searched.

One aspect of the present invention provides a program causing a computer to function as:
an acquisition unit that acquires a plurality of camera images photographed by a plurality of cameras installed within a facility;
a camera image determination unit that determines, based on at least one of weather information on a day, schedule information of each surveillance target person on the day, and a behavior tendency of each surveillance target person within a facility, the camera image for which each of the surveillance target persons is searched from among a plurality of the camera images; and
a search unit that searches for each of the surveillance target persons from among each of the camera images being determined as a target for which each of the surveillance target persons is searched.

According to one aspect of the present invention, an image processing apparatus, an image processing method, and a program that achieve a task of reducing a load on a computer in processing of searching for each of a plurality of surveillance target persons from among a plurality of images photographed by a plurality of cameras installed within a facility are achieved.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating one example of a functional block diagram of an image processing apparatus.

FIG. 2 is a diagram illustrating one example of a hardware configuration of the image processing apparatus.

FIG. 3 is a flowchart illustrating one example of a flow of processing of the image processing apparatus.

FIG. 4 is a diagram illustrating another example of the functional block diagram of the image processing apparatus.

FIG. 5 is a diagram schematically illustrating one example of tracking information.

FIG. 6 is a diagram schematically illustrating one example of a screen to be displayed by an external apparatus.

FIG. 7 is a diagram schematically illustrating another example of the screen to be displayed by the external apparatus.

FIG. 8 is a sequence diagram illustrating one example of a flow of processing of the image processing apparatus.

FIG. 9 is a diagram illustrating another example of the functional block diagram of the image processing apparatus.

FIG. 10 is a diagram schematically illustrating one example of behavior history information.

FIG. 11 is a diagram schematically illustrating one example of a registered comment.

FIG. 12 is a diagram schematically illustrating another example of the screen to be displayed by the external apparatus.

FIG. 13 is a diagram illustrating another example of the functional block diagram of the image processing apparatus.

FIG. 14 is a diagram illustrating another example of the functional block diagram of the image processing apparatus.

FIG. 15 is a diagram schematically illustrating one example of a behavior report.

### DESCRIPTION OF EMBODIMENTS

Hereinafter, example embodiments according to the present invention are described by using the drawings. Note that, in all drawings, a similar constituent element is indicated by a similar reference sign, and description thereof is omitted as necessary.

### First Example Embodiment

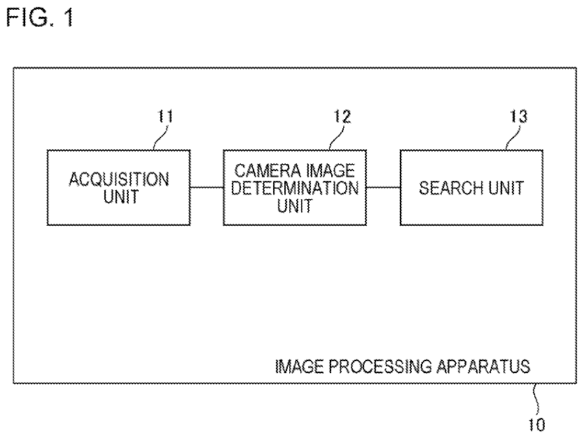

FIG. 1 is a functional block diagram illustrating an overview of an image processing apparatus 10 according to a first example embodiment. The image processing apparatus 10 includes an acquisition unit 11, a camera image determination unit 12, and a search unit 13.

The acquisition unit 11 acquires a plurality of camera images photographed by a plurality of cameras installed within a facility. The camera image determination unit 12 determines, based on at least one of weather information on a day, schedule information of each surveillance target person on the day, and a behavior tendency of each surveillance target person within a facility, the camera image for which each of the surveillance target persons is searched from among a plurality of the camera images. The search unit 13 searches for each of the surveillance target persons from among each of the camera images being determined as a target for which each of the surveillance target persons is searched.

According to the image processing apparatus 10 including a configuration as described above, a task of reducing a load on a computer in processing of searching for each of a plurality of surveillance target persons from among a plurality of images photographed by a plurality of cameras installed within a facility is achieved.

### Second Example Embodiment

### Overview

An image processing apparatus 10 according to a second example embodiment is an apparatus in which the image processing apparatus 10 according to the first example embodiment is further embodied. The image processing apparatus 10 according to the present example embodiment does not perform processing of searching for each of a plurality of surveillance target persons by handling, as a processing target, all of a plurality of camera images generated by a plurality of cameras, but narrows down a camera image for which each of surveillance target persons is searched, based on at least one of weather information on a day, schedule information of each surveillance target person on the day, and a behavior tendency of each surveillance target person within a facility. Narrowing down a camera image for which each of surveillance target persons is searched reduces a load on a computer in processing of searching for each of a plurality of surveillance target persons from among a plurality of camera images. Hereinafter, a configuration of the image processing apparatus 10 is described in detail.

### “Hardware Configuration”

Next, one example of a hardware configuration of the image processing apparatus 10 is described. Each functional unit of the image processing apparatus 10 is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

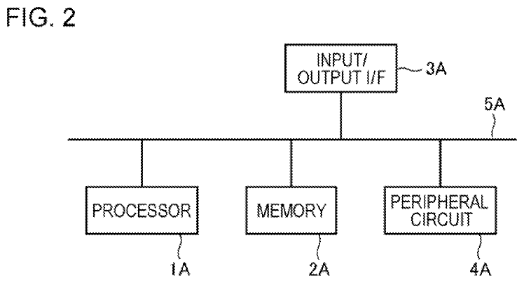

FIG. 2 is a block diagram illustrating a hardware configuration of the image processing apparatus 10. As illustrated in FIG. 2, the image processing apparatus 10 includes a processor 1A, a memory 2A, an input/output interface 3A, a peripheral circuit 4A, and a bus 5A. The peripheral circuit 4A includes various modules. The image processing apparatus 10 may not include the peripheral circuit 4A. Note that, the image processing apparatus 10 may be constituted of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on these arithmetic operation results.

### “Functional Configuration”

Next, a functional configuration of the image processing apparatus 10 according to the second example embodiment is described. FIG. 1 illustrates one example of a functional block diagram of the image processing apparatus 10. As illustrated in FIG. 1, the image processing apparatus 10 includes an acquisition unit 11, a camera image determination unit 12, and a search unit 13.

The acquisition unit 11 acquires a plurality of camera images photographed by a plurality of cameras installed within a facility.

The facility is a facility utilized by a person (surveillance target person) to be surveyed, and, for example, is a nursery school, a kindergarten, a school, a cram school, a sports facility, an extracurricular activity facility, a facility related to a lesson, a classroom, and the like. In a case of these exemplified facilities, a child and the like who perform an activity within the facility become a surveillance target person, and a parent, a worker in the facility, and the like become a surveillant who surveys a surveillance target person. Note that, the facility is not limited to the examples herein. Further, the surveillance target person is not limited to a child. For example, the facility may include a rehabilitation facility, an elderly care facility, and the like. In this case, an adult (such as a person in rehabilitation in a rehabilitation facility, and an elderly person staying in an elderly care facility) becomes a surveillance target person, and a relative of the adult, a worker in the facility, and the like become a surveillant.

The camera may photograph a moving image, or may repeatedly photograph a still image at a predetermined time interval. The camera may be installed at a predetermined position within the facility. In addition, the camera may be mounted on a moving body moving within the facility. Further, both of a camera installed at a predetermined position within the facility, and a camera mounted on the moving body may be utilized.

The acquisition unit 11 acquires a plurality of camera images photographed by each of a plurality of cameras by real-time processing or by batch processing. A means for achieving acquisition of camera images photographed by a plurality of cameras is not specifically limited. For example, a plurality of cameras and the image processing apparatus 10 may be configured to be communicable with each other. Further, each of the plurality of cameras may transmit a photographed camera image to the image processing apparatus 10. In addition, camera images photographed by the plurality of cameras may be accumulated in a storage apparatus by any means. Further, camera images accumulated in the storage apparatus may be input to the image processing apparatus 10 by any means. Note that, the example is merely one example, and the present example embodiment is not limited to the configuration.

The camera image determination unit 12 determines, based on at least one of weather information on a day, schedule information of each surveillance target person on the day, and a behavior tendency of each surveillance target person within a facility, a camera image for which each of surveillance target persons is searched from among a plurality of the camera images. Hereinafter, details are described.

### —Processing of Determining Based on Weather Information on a Day—

The processing is utilized in a facility including an indoor activity area and an outdoor activity area. At a timing when weather information indicates a first weather, the camera image determination unit 12 determines a camera image photographed by a camera that photographs an indoor activity area, as a camera image for which a surveillance target person is searched, and does not determine a camera image photographed by a camera that photographs an outdoor activity area, as a camera image for which the surveillance target person is searched. Further, at a timing when weather information does not indicate the first weather, the camera image determination unit 12 determines camera images photographed by all cameras, as camera images for which the surveillance target person is searched.

The “first weather” is a weather in which an outdoor activity is restricted, and, for example, is exemplified as “rain”, “hail”, “fine, and a temperature is equal to or more than a predetermined value (example: 30° C. or higher)”, or the like, but the present example embodiment is not limited thereto.

The “weather information” can include at least one of a weather forecast, an analysis result of a camera image, and sensing information by a sensor.

For example, the camera image determination unit 12 may acquire a weather forecast from a predetermined server providing a weather forecast, or may acquire a weather forecast being input to the image processing apparatus 10 by a user. The weather forecast indicates weather, temperature, and the like at each timing.

Further, the camera image determination unit 12 may analyze “a camera image photographed by a camera that photographs outdoors” among a camera image acquired by the acquisition unit 11, and determine weather of a facility at each timing. For example, the camera image determination unit 12 may determine whether weather at each timing is rainy by detecting rain captured in an image.

In addition, the camera image determination unit 12 may acquire, from a temperature sensor, information indicating a temperature measured by the temperature sensor installed at any position (e.g., outdoors) within a facility.

### —Processing of Determining Based on Schedule Information of Each Surveillance Target Person on a Day—

The processing is utilized in a facility in which an activity schedule of each surveillance target person within the facility on each day is determined in advance. In the activity schedule, a time period, an activity content, and an activity area are indicated. For example, “playing outside in a playground from 9 to 10 o'clock” and the like are exemplified, but the present example embodiment is not limited thereto.

Further, in an activity schedule of a certain surveillance target person, at a timing when the surveillance target person is scheduled to perform an activity in a predetermined activity area, the camera image determination unit 12 determines a camera image photographed by a camera that photographs the predetermined activity area, as a camera image for which the surveillance target person is searched, and does not determine a camera image photographed by a camera that photographs another activity area, as a camera image for which the surveillance target person is searched. For example, in a case of a surveillance target person in which a schedule “playing outside in a playground from 9 to 10 o'clock” is indicated in an activity schedule, the camera image determination unit 12 determines, from 9 to 10 o'clock, a camera image photographed by a camera that photographs the playground, as a camera image for which the surveillance target person is searched, and does not determine a camera image photographed by another camera, as a camera image for which the surveillance target person is searched.

By the way, the activity schedule may be determined in advance for each surveillance target person, and stored in a storage apparatus of the image processing apparatus 10 in association with identification information of each surveillance target person. In this case, the camera image determination unit 12 reads, from the storage apparatus, an activity schedule of each target surveillance person being associated with identification information on a day, and performs the above-described processing. In addition, the activity schedule may be determined in advance for each group, and stored in the storage apparatus of the image processing apparatus in association with identification information of each group. In this case, group information indicating to which group, each surveillance target person belongs is further stored in the storage apparatus of the image processing apparatus 10. Further, the camera image determination unit 12 determines a group to which each surveillance target person belongs, based on identification information of each surveillance target person and the above-described group information, thereafter, reads, from the storage apparatus, an activity schedule of the determined group being associated with identification information on a day, and performs the above-described processing.

—Processing of Determining Based on Behavior Tendency of Each Surveillance Target Person within Facility—

In the processing, a behavior tendency of each surveillance target person within a facility is computed in advance, based on a camera image in the past, and stored in the storage apparatus of the image processing apparatus 10 in association with identification information of each surveillance target person. In the behavior tendency, a tendency of each surveillance target person in an activity area is indicated for each situation. The situation is divided into cases, based on various factors such as weather, temperature, a season, a month, a day of week, and a time period.

Computation of a tendency in an activity area is achieved by utilizing any available technique. For example, first, presence history information of each surveillance target person is generated by using an image analysis technique. The presence history information indicates when and where each surveillance target person has been present. For example, as the presence history information, information such as “in a playground from 9 to 10 o'clock, May 9, 2022” is accumulated for each surveillance target person. Further, situation information indicating a situation at each timing in the past is generated, and stored in the storage apparatus of the image processing apparatus 10. For example, as the situation information, information such as “from 9 to 10 o'clock, May 9 (Mon), 2022, fine, 18° C.” is accumulated. Further, a tendency of each surveillance target person in an activity area is computed for each situation by predetermined arithmetic processing based on the presence history information and situation information. An algorithm of computation is not specifically limited.

After determining a situation at each timing, the camera image determination unit 12 determines an activity area where each surveillance target person tends to be present under a situation at each timing, based on a tendency of each surveillance target person in an activity area for each situation as described above. Further, the camera image determination unit 12 determines, as a camera image for which a surveillance target person is searched, a camera image photographed by a camera that photographs an activity area where each surveillance target person tends to be present under a situation at each timing, and does not determine, as a camera image for which the surveillance target person is searched, a camera image photographed by a camera other than the above. Note that, a situation at each timing is determined based on various factors such as weather, temperature, a season, a month, a day of week, and a time period. The camera image determination unit 12 can acquire information on these various factors by any means, and determine a situation at each timing.

—Processing of Determining Based on Plurality of Pieces of Information Among Weather Information on a Day, Schedule Information of Each Surveillance Target Person on the Day, and Behavior Tendency of Each Surveillance Target Person within Facility—

After determining a camera image for which a certain surveillance target person is searched, based on each of the above-described plurality of pieces of information, the camera image determination unit 12 determines, as a camera image for which the surveillance target person is searched, “a camera image determined based on at least one piece of information”, “a camera image determined based on a predetermined number of pieces or more of information”, or “a camera image determined based on all pieces of information”.

The search unit 13 searches for each of surveillance target persons from among each of the camera images being determined as a target for which each of surveillance target persons is searched. A feature value (such as face information) of an external appearance of each of surveillance target persons is stored in advance in the image processing apparatus 10. The search unit 13 searches for each of surveillance target persons from among each of the above-described determined camera images by using the feature value. Note that, the search unit 13 does not perform processing of searching for each of surveillance target persons with respect to a camera image that is not determined as a target for which each of surveillance target persons is searched.

Herein, a modification example of search processing of the search unit 13 is described. In the modification example, the search unit 13 performs search processing by dividing the processing into two steps.

In a first step, the search unit 13 searches for each of surveillance target persons from among each of camera images being determined as a target for which each of surveillance target persons is searched. Further, the search unit 13 does not perform processing of searching for each of surveillance target persons with respect to a camera image that is not determined as a target for which each of surveillance target persons is searched.

In the above-described first step, in a case where each of surveillance target persons cannot be detected from any of camera images being determined as a target for which each of surveillance target persons is searched, the search unit 13 performs a second step. In the above-described first step, in a case where each of surveillance target persons can be detected from one of camera images being determined as a target for which each of surveillance target persons is searched, the search unit 13 does not perform the second step.

In the second step, the search unit 13 searches for each of surveillance target persons from among each of the camera images that are not determined as a target for which each of surveillance target persons is searched.

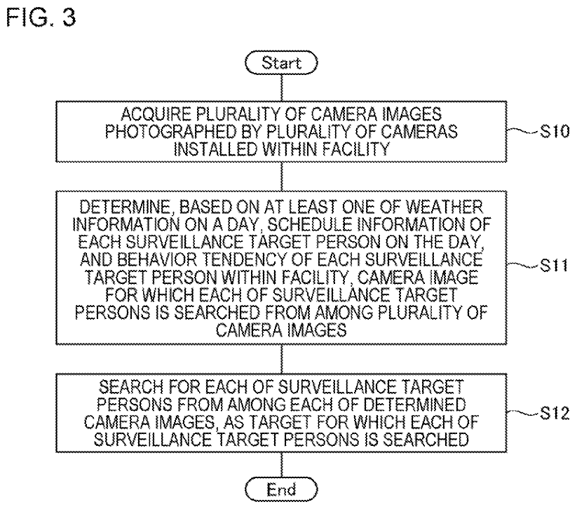

Next, one example of a flow of processing of the image processing apparatus 10 is described by using a flowchart in FIG. 3.

First, the image processing apparatus 10 acquires a plurality of camera images photographed by a plurality of cameras installed within a facility (S10).

Subsequently, the image processing apparatus 10 determines, based on at least one of weather information on a day, schedule information of each surveillance target person on the day, and a behavior tendency of each surveillance target person within a facility, a camera image for which each of surveillance target persons is searched from among a plurality of the camera images (S11). The image processing apparatus 10 determines a camera image for which each of surveillance target persons is searched at each timing, based on at least one of weather, a schedule, and a behavior tendency at each timing.

Subsequently, the image processing apparatus 10 searches for each of surveillance target persons from among each of the camera images being determined as a target for which each of surveillance target persons is searched (S12).

### “Advantageous Effect”

The image processing apparatus 10 according to the present example embodiment narrows down a camera image for which each of surveillance target persons is searched, based on at least one of weather information on a day, schedule information of each surveillance target person on the day, and a behavior tendency of each surveillance target person within a facility. Narrowing down a camera image for which each of surveillance target persons is searched reduces a load on a computer in processing of searching for each of a plurality of surveillance target persons from a plurality of camera images.

Further, performing the above-described narrowing down based on distinctive information being weather information on a day, schedule information of each surveillance target person on the day, and a behavior tendency of each surveillance target person within a facility enables to accurately narrow down a camera image in which a surveillance target person is highly likely to be captured.

### Third Example Embodiment

An image processing apparatus 10 according to a present example embodiment includes a function of determining, from among a plurality of cameras, a camera being presumed to be photographing a surveillance target person specified by a surveillant, and outputting a camera image photographed by the determined camera to an external apparatus. The surveillant can recognize a situation of the surveillance target person by browsing the output camera image. Hereinafter, details are described.

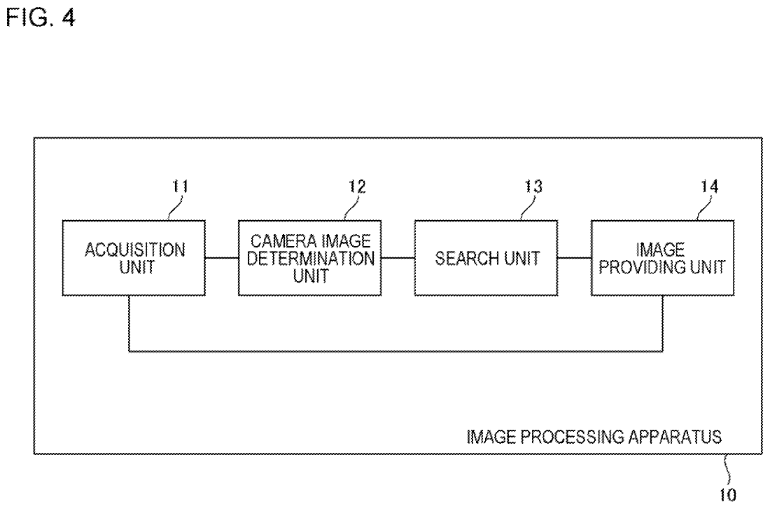

FIG. 4 illustrates one example of a functional block diagram of the image processing apparatus 10. As illustrated in FIG. 4, the image processing apparatus 10 includes an acquisition unit 11, a camera image determination unit 12, a search unit 13, and an image providing unit 14.

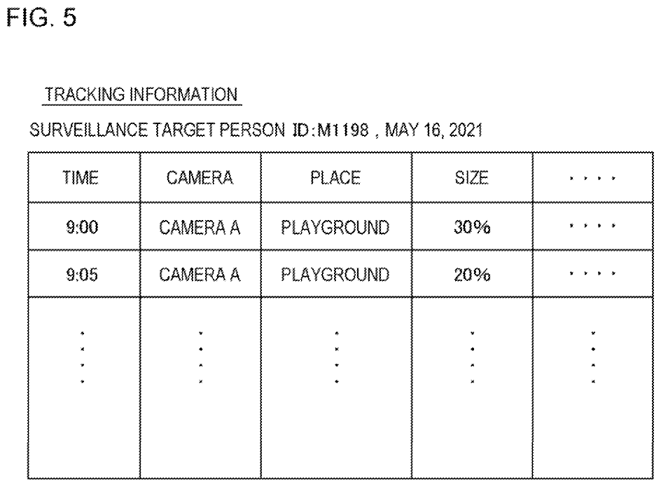

In the present example embodiment, the acquisition unit 11, the camera image determination unit 12, and the search unit 13 perform the processing described in the second example embodiment by real-time processing. Further, the search unit 13 generates tracking information as illustrated in FIG. 5 for each surveillance target person, based on a result of search.

In the tracking information illustrated in FIG. 5, a date, a time, a camera that photographs each surveillance target person at each time, a place to be photographed by the camera, and a size of each surveillance target person within a camera image are registered in association with one another.

The illustrated tracking information is information for every five minutes, but this is one example. The tracking information may be, for example, information for every shorter time such as for every one minute, for every ten seconds, for every one second, or for every one frame image. Further, the tracking information may be information for every longer time such as for every ten minutes or for every fifteen minutes.

The search unit 13 can search each surveillance target person within a camera image by the search processing described in the second example embodiment. Further, the search unit 13 can determine a camera that photographs each surveillance target person at each time, based on a result of the search.

In a case where a camera is a stationary type camera, a place to be photographed by the camera is fixed. Therefore, each camera and a place to be photographed by each camera may be registered in advance in the image processing apparatus 10 in association with each other. The search unit 13 can determine a place to be photographed by each camera, based on the information.

In addition, in a case where a camera is mounted on a moving body moving within a facility, a current position of the moving body may be determined by utilizing a global positioning system (GPS), processing of detecting a landmark within a camera image, and the like, and a history on the current position may be accumulated. The search unit 13 can determine a place (a place to be photographed) where a camera mounted on a moving body is present at each time, based on the information.

A size of each surveillance target person within a camera image may be expressed, for example, by a ratio occupied by an area where a surveillance target person is captured within the camera image. Note that, a size of each surveillance target person within a camera image may be indicated by another method such as a pixel number of an area where the surveillance target person is captured within the camera image. The area where a surveillance target person is captured within a camera image may be a rectangular area including the surveillance target person, or may be an area where only a surveillance target person determined along a contour of a body of the surveillance target person is captured.

Note that, in the tracking information in FIG. 5, only one camera is indicated as a camera that photographs each surveillance target person at one time, but two or more cameras may be indicated as cameras that photograph each surveillance target person at one time.

The image providing unit 14 determines a camera being presumed to be photographing one specified surveillance target person at a current time, based on a result of search by the search unit 13. Further, the image providing unit 14 transmits, to the external apparatus, a camera image photographed by the determined camera. A means for specifying one surveillance target person from among a plurality of surveillance target persons is not specifically limited, and any available technique can be adopted. The image providing unit 14 can perform the following image providing processing example 1 or 2.

### —Image Providing Processing Example 1—

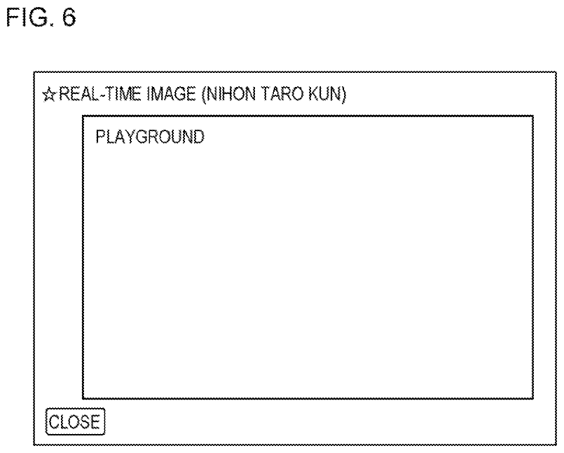

The image providing unit 14 determines, as a camera being presumed to be photographing a specified surveillance target person at a current time, a camera that photographs the specified surveillance target person at a latest time, based on the tracking information as illustrated in FIG. 5. Further, the image providing unit 14 transmits, to the external apparatus, a camera image photographed by the determined camera. For example, the image providing unit 14 transmits, to the external apparatus, a camera image photographed by the determined camera by real-time processing. Consequently, as illustrated in FIG. 6, a real-time image photographed by the determined camera is displayed on the external apparatus. As described above, in the example, live streaming of a camera image photographed by a camera is achieved. As illustrated in FIG. 6, text information indicating a photographing place of a camera may be displayed on a camera image in a superimposed manner.

Note that, in a case where there are a plurality of cameras that photograph a specified surveillance target person at a latest time, the image providing unit 14 may perform the following processing.

As one example, the image providing unit 14 may determine a camera that captures a specified surveillance target person with a larger size as a camera being presumed to be photographing the specified surveillance target person at a current time. Further, the image providing unit 14 may transmit, to the external apparatus, a camera image photographed by the determined camera.

As another example, the image providing unit 14 may determine, as a camera being presumed to be photographing a specified surveillance target person at a current time, all of a plurality of cameras that photograph the specified surveillance target person at a latest time. Further, the image providing unit 14 may transmit, to the external apparatus, a plurality of camera images photographed by the determined plurality of cameras.

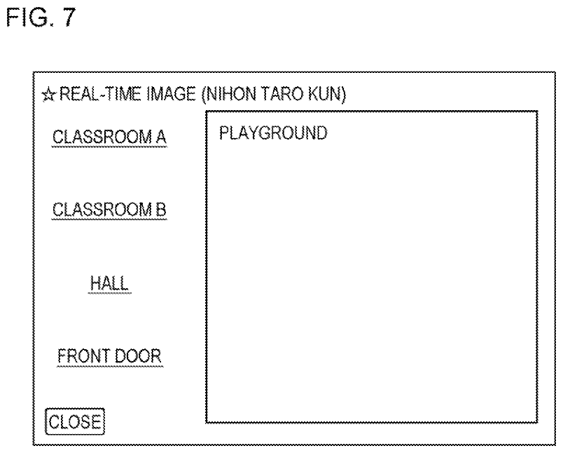

In this case, the plurality of camera images may be displayed in the external apparatus in a multiple manner. In addition, as illustrated in FIG. 7, only a camera image by one camera may be displayed, and candidate information in which other cameras are displayed in a selectable manner may be further displayed. Further, a camera image to be displayed may be switchable in response to a user operation. The image providing unit 14 can accept an input of specifying one from among the candidate information, and transmit, to the external apparatus, a camera image photographed by the specified camera. Note that, one camera that displays a camera image for the first time may be, for example, a camera in which a specified surveillance target person is captured with a largest size, or may be a camera other than the above.

In a case of the example in FIG. 7, a camera image by a camera that photographs a playground is displayed, and photographing places of other cameras are displayed in a selectable manner. For example, when “a classroom A” is selected from the state in FIG. 7, display of a camera image of a playground is finished, and instead, display of a camera image on the classroom A is started. Note that, photographing places of a plurality of cameras that are displayed in a selectable manner in FIG. 7 may be simply displayed as a list, or may be displayed in ranking. In a case of ranking display, for example, a camera in which a specified surveillance target person is captured with a larger size can be set at a higher rank. Specifically, the image providing unit 14 can perform ranking for ranking display on candidate information, based on a size of a surveillance target person within a camera image.

As another example, the image providing unit 14 may determine, as a camera being presumed to be photographing a specified surveillance target person at a current time, a camera in which the specified surveillance target person is captured with a size being equal to or more than a predetermined value from among a plurality of cameras that photograph the specified surveillance target person at a latest time. Further, the image providing unit 14 may transmit, to the external apparatus, a camera image photographed by the determined one or a plurality of cameras. In a case where a plurality of cameras are determined, a plurality of camera images photographed by the plurality of cameras may be displayed in the external apparatus in a multiple manner. In addition, display as illustrated above in FIG. 7 may be performed.

### —Image Providing Processing Example 2—

The image providing unit 14 determines, based on the tracking information as illustrated in FIG. 5, as a camera being presumed to be photographing a specified surveillance target person at a current time, a camera that photographs the specified surveillance target person at a latest time, and a camera that photographs the specified surveillance target person within a most recent predetermined time (example: such as one minute, thirty seconds, or ten seconds). Further, the image providing unit 14 transmits, to the external apparatus, a camera image photographed by the determined one or a plurality of cameras. For example, the image providing unit 14 transmits, to the external apparatus, a camera image photographed by the determined one or a plurality of cameras by real-time processing. In this way, in the example, live streaming of a camera image photographed by a camera is achieved.

In a case where one camera is determined, for example, as illustrated in FIG. 6, a real-time image photographed by the determined one camera is displayed in the external apparatus. On the other hand, in a case where a plurality of cameras are determined, a plurality of camera images photographed by the plurality of cameras may be displayed in the external apparatus in a multiple manner. In addition, display as illustrated above in FIG. 7 may be performed.

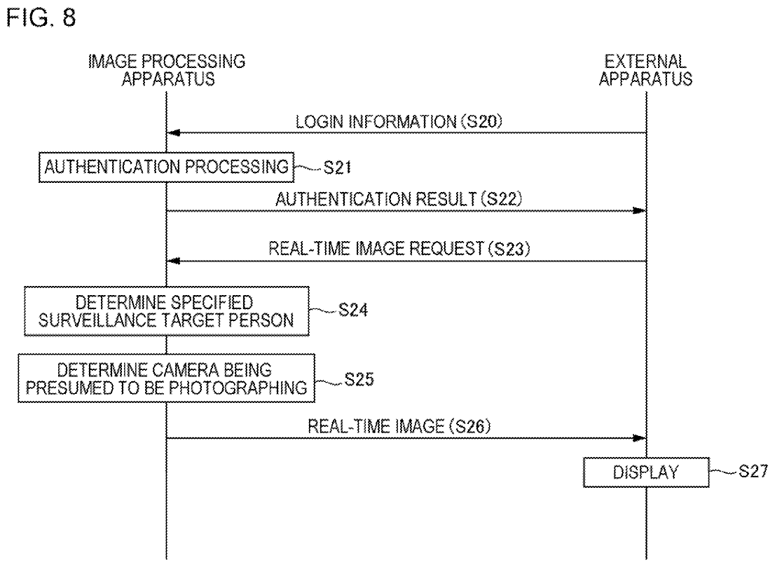

Next, one example of a flow of processing of the image processing apparatus 10 is described by using a sequence diagram in FIG. 8.

First, a surveillant accesses to the image processing apparatus 10 by operating the external apparatus, and transmits login information (S20). The external apparatus is a smartphone, a tablet terminal, a mobile phone, a personal computer, a smartwatch, or the like, but the present example embodiment is not limited thereto. The external apparatus and the image processing apparatus 10 are connected to each other via a communication network such as the Internet.

After performing authentication processing, based on the acquired login information (S21), the image processing apparatus 10 transmits an authentication result to the external apparatus (S22). Herein, it is assumed that authentication is successful, and a predetermined screen after login is transmitted from the image processing apparatus 10 to the external apparatus.

The surveillant performs a predetermined operation on the predetermined screen after login, and requests for a real-time image. In response to the operation, the external apparatus transmits, to the image processing apparatus 10, a request for a real-time image (S23).

Thereafter, the image processing apparatus 10 determines a specified surveillance target person, based on login information (S24). For example, various pieces of user information are registered in advance in the image processing apparatus 10 in association with user identification information. The user information includes identification information of a surveillance target person. Further, the image processing apparatus 10 determines, as identification information of the specified surveillance target person, identification information of the surveillance target person being associated with the user identification information included in the login information.

Subsequently, the image processing apparatus 10 determines a camera being presumed to be photographing the specified surveillance target person (S25). In the present example embodiment, the acquisition unit 11, the camera image determination unit 12, and the search unit 13 perform the processing described in the second example embodiment by real-time processing. Further, the search unit 13 generates tracking information as illustrated in FIG. 5 for each surveillance target person, based on a result of search. The image processing apparatus 10 determines the camera being presumed to be photographing the specified surveillance target person, based on the tracking information.

Subsequently, the image processing apparatus 10 transmits, to the external apparatus, a camera image generated by the determined camera by real-time processing (S26). Further, the external apparatus displays the received camera image (S27). In the processing, live streaming of a camera image photographed by a camera is achieved.

Other configurations of the image processing apparatus 10 according to the present example embodiment are similar to the configurations of the image processing apparatus 10 according to the first and second example embodiments.

In the image processing apparatus 10 according to the present example embodiment, an advantageous effect similar to that of the image processing apparatus 10 according to the first and second example embodiments is achieved. Further, in the image processing apparatus 10 according to the present example embodiment, it is possible to provide live streaming of a camera image being photographing inside a facility to a predetermined surveillant.

By the way, in a case where a plurality of cameras photograph the inside of a facility, it is also possible to provide live streaming in which all of a plurality of camera images photographed by the plurality of cameras are transmitted to the external apparatus for display. However, in a case of a configuration described above, a processing load and a communication load on a computer increase. Further, a surveillant needs to search for, from a plurality of camera images, a camera image in which a surveillance target person to be surveyed by the surveillant himself/herself is captured, which is very troublesome.

As described in the present example embodiment, configuring in such a way that a camera being presumed to be photographing a specified surveillance target person is determined, and a camera image photographed by the determined camera is transmitted to the external apparatus enables to reduce the above-described inconvenience.

Further, configuring in such a way that not only a camera being photographs a specified surveillance target person at a latest time, but also a camera being photographs the specified surveillance target person within a most recent predetermined time (example: one minute, thirty seconds, ten seconds, or the like) are determined as a camera being presumed to be photographing the specified surveillance target person at a current time, and camera images photographed by these cameras are transmittable to the external apparatus enables to provide a surveillant with a camera image including the surveillance target person with a high probability.

### Fourth Example Embodiment

An image processing apparatus 10 according to a present example embodiment includes a function of providing a surveillant with a camera image of a surveillance target person by a means different from live streaming as described in the third example embodiment. Specifically, the image processing apparatus 10 selects a camera image that satisfies a predetermined condition by analyzing the camera image, and provides a surveillant with the selected camera image. Hereinafter, details are described.

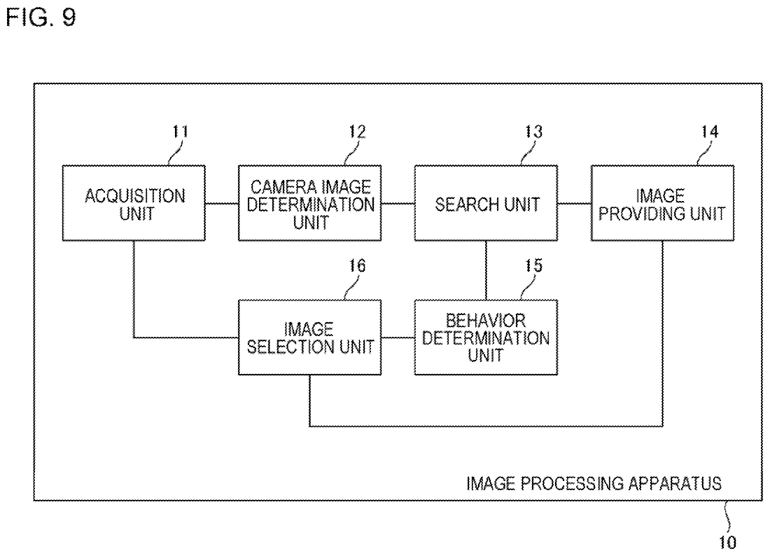

FIG. 9 illustrates one example of a functional block diagram of the image processing apparatus 10. As illustrated in FIG. 9, the image processing apparatus 10 includes an acquisition unit 11, a camera image determination unit 12, a search unit 13, an image providing unit 14, a behavior determination unit 15, and an image selection unit 16.

The behavior determination unit 15 determines behavior made by each of surveillance target persons, based on a result of search by the search unit 13, and generates behavior history information. More specifically, the behavior determination unit 15 determines a camera image in which each of surveillance target persons is captured, based on a result of search by the search unit 13, determines behavior made by each surveillance target person by analyzing the determined camera image, and generates behavior history information.

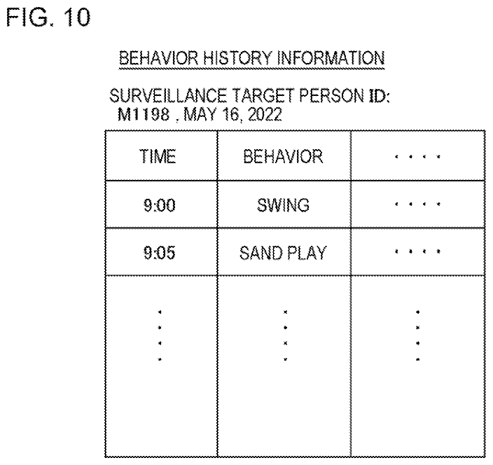

The behavior history information indicates when and what, each surveillance target person has done. For example, as illustrated in FIG. 10, information indicating a content of behavior and a behavior execution time such as “from 9:00 to 9:05, May 16, 2022, swing” is accumulated as the behavior history information for each surveillance target person.

A means for determining behavior by an image analysis is not specifically limited, and any available technique can be utilized. For example, it may be possible to determine behavior made by a surveillance target person by detecting a unique pose when each piece of behavior is made by a pose detection technique. In addition, it may be possible to determine behavior made by a surveillance target person by detecting an object (example: a swing or the like) utilized when each piece of behavior is made by an object detection technique.

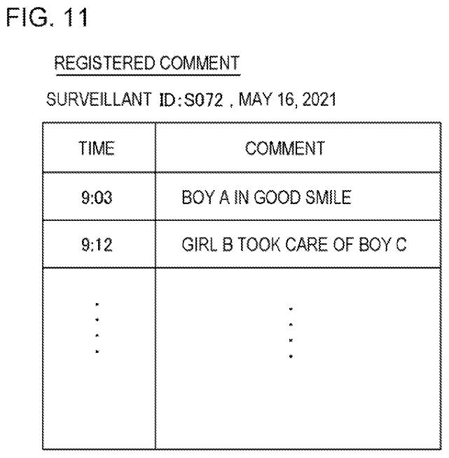

In addition, the behavior determination unit 15 may acquire a comment input by a worker in a facility, and include the comment in the behavior history information. When a worker in a facility finds an event that should be reported to another surveillant or the like when surveying a surveillance target person, the worker registers a comment indicating the event in a storage apparatus of the image processing apparatus 10. The worker in the facility registers a comment indicating who made what behavior, for example, such as “a boy A in good smile” or “a girl B took care of a boy C”. As illustrated in FIG. 11, for example, a comment and a time registered by the worker in the facility are stored in the storage apparatus of the image processing apparatus 10 in association with each other.

The behavior determination unit 15 searches for a comment relating to each surveillance target person by searching for, from among registered comments as illustrated in FIG. 11, a name, a nickname, a common name, or the like of each surveillance target person. Further, the behavior determination unit 15 includes, in behavior history information of each surveillance target person, a pair of a comment relating to each surveillance target person, and a time of the comment.

An input of a comment by a worker in a facility is achieved by utilizing any available technique. For example, a worker in a facility inputs a predetermined comment at any timing via a portable terminal such as a smartphone, a mobile phone, a smartwatch, and a wearable terminal. The input of the comment may be achieved via an input apparatus such as a touch panel or a physical button, or may be achieved by voice input.

The image selection unit 16 selects a camera image that satisfies a predetermined condition for each surveillance target person, based on behavior history information generated by the behavior determination unit 15. The image selection unit 16 selects, from among a camera image in which each of surveillance target persons searched by the search unit 13 is captured, a camera image that satisfies a predetermined condition for each surveillance target person. Note that, the camera image selected by the image selection unit 16 is provided to a surveillant. Therefore, the predetermined condition is defined in such a way that a camera image that should be provided to a surveillant is selected.

For example, the predetermined condition can be set as a condition in which one or a plurality of the following conditions are connected by a predetermined logical operator:
“a camera image photographed at a timing when predetermined behavior being defined in advance is made”
“a camera image photographed at a timing when behavior that has not been made in the past is made”
“a camera image photographed at a timing when a comment relating to each surveillance target person is registered by a worker in a facility”
“a camera image in which a size of each surveillance target person within the camera image becomes equal to or more than a reference value”.

“Behavior that has not been made in the past” is determined based on behavior history information on the day, and behavior history information in the past. Specifically, the image selection unit 16 can determine, as behavior that has not been made in the past, behavior that is not included in behavior history information in the past among behavior included in behavior history information on the day.

As another example, the image selection unit 16 may select a camera image being determined to be a best shot, for example, based on a best shot detection technique disclosed in Japanese Patent Application Publication No. 2016-52013, or Japanese Patent Application Publication No. 2018-163700.

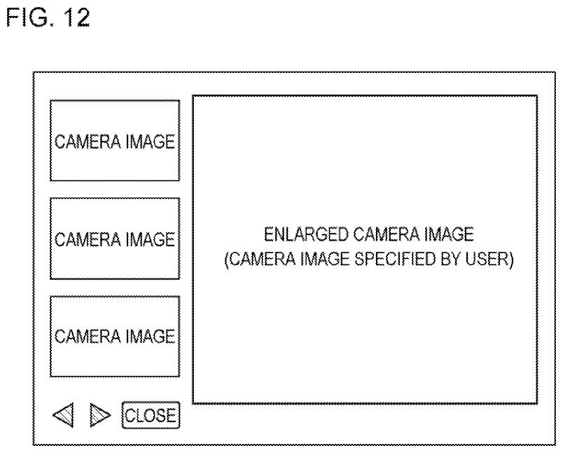

The image providing unit 14 transmits, to an external apparatus, a camera image selected by the image selection unit 16 in association with a specified surveillance target person in response to an image request being input by a surveillant via the external apparatus. Further, as illustrated in FIG. 12, the external apparatus displays an image including the selected camera image. In the example in FIG. 12, one (camera image specified by a user) of the selected camera images is displayed in an enlarged manner, and the other selected camera images are specifiably displayed as a list. Note that, a specification method of a surveillance target person is as described in the third example embodiment.

The image providing unit 14 may transmit, to the external apparatus, a still image, specifically, one or a plurality of camera images selected by the image selection unit 16. In addition, the image providing unit 14 may transmit, to the external apparatus, a moving image, specifically, a moving image for a predetermined time including one or a plurality of camera images selected by the image selection unit 16, and a camera image preceding and/or succeeding thereto in time series order.

Note that, the image providing unit 14 may apply predetermined processing to a camera image, before transmitting the camera image to the external apparatus, and transmit the camera image after the processing to the external apparatus. The predetermined processing is processing of preventing a person other than a specified surveillance target person from being specifiable. For example, the image providing unit 14 can apply, to a face of a person other than a surveillance target person, mosaic processing, blur processing, mask processing (processing of making a face unrecognizable by superimposing a predetermined mask image on a face portion), and the like. The image providing unit 14 may perform the above-described processing after receiving the above-described image request; or perform the above-described processing at any timing before receiving the above-described image request, and save a camera image after the processing in the storage apparatus of the image processing apparatus 10. In a case of the present example embodiment, unlike live streaming, it is possible to secure a time for performing the above-described processing before a camera image is transmitted to the external apparatus after the camera image is generated. By performing the above-described processing, privacy of other surveillance target persons is protected, which is preferable.

Other configurations of the image processing apparatus 10 according to the present example embodiment are similar to the configurations of the image processing apparatus 10 according to the first to third example embodiments.

In the image processing apparatus 10 according to the present example embodiment, an advantageous effect similar to that of the image processing apparatus 10 according to the first to third example embodiments is achieved. Further, the image processing apparatus 10 according to the present example embodiment can provide a predetermined surveillant with a camera image that satisfies a predetermined condition among a camera image photographed in a facility.

By the way, in a case where a plurality of cameras photograph inside a facility, it is also possible to transmit, to the external apparatus, all of a plurality of camera images photographed by the plurality of cameras for display. However, in a case of a configuration as described above, a processing load and a communication load on a computer increase. Further, a surveillant needs to search for, from a plurality of camera images, a camera image in which a surveillance target person to be surveyed by the surveillant himself/herself is captured, or a desired camera image, which is very troublesome.

As described in the present example embodiment, selecting a camera image that satisfies a predetermined condition from among a camera image in which a specified surveillance target person is captured, and providing the selected camera image to a surveillant enables to reduce the above-described inconvenience.

### Fifth Example Embodiment

An image processing apparatus 10 according to a present example embodiment includes a function of determining a missing person, based on a search result by a search unit 13. Hereinafter, details are described.

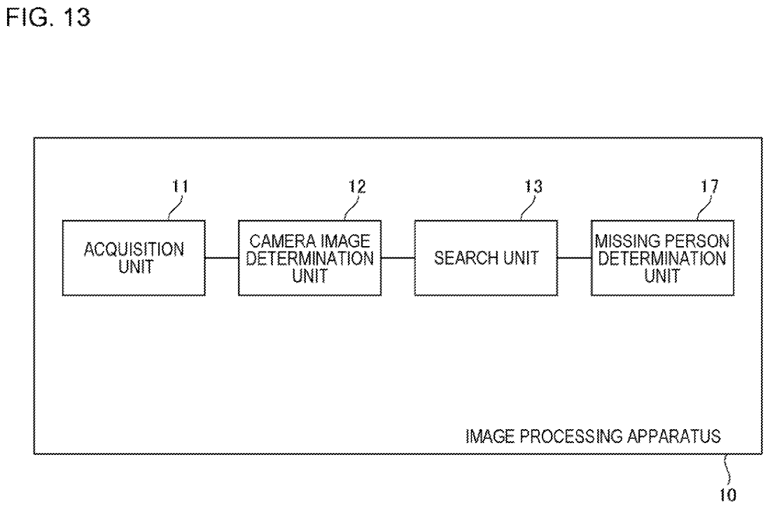

FIG. 13 illustrates one example of a functional block diagram of the image processing apparatus 10. As illustrated in FIG. 13, the image processing apparatus 10 includes an acquisition unit 11, a camera image determination unit 12, a search unit 13, and a missing person determination unit 17. Although not illustrated, the image processing apparatus 10 may further include at least one of an image providing unit 14, a behavior determination unit 15, and an image selection unit 16.

The missing person determination unit 17 determines, as a missing person, a surveillance target person whose state (state in which a surveillance target person is not captured in any of a plurality of camera images photographed by a plurality of cameras) in which a surveillance target person is not photographed by any of the cameras is continued for a predetermined time or longer, based on a result of search by the search unit 13. The predetermined time is a time being determined in advance, for example, such as 5 minutes or 10 minutes, and is determined according to the number of installed cameras, presence or absence of a blind spot of a camera, a size of the blind spot, and the like.

The missing person determination unit 17 can notify to a predetermined surveillant, in a case where a missing person is determined. The surveillant to be notified is, for example, a worker in a facility, a parent or a relative of a surveillance target person who is missing, or the like. The notification may be achieved by displaying warning information on a display installed in a facility, outputting a warning sound via a speaker installed in a facility, or turning on a warning lamp installed in a facility. Further, the missing person determination unit 17 may transmit warning information to a predetermined notification party by utilizing an electronic mail, a push notification of an application, or the like.

The warning information includes information (such as a name) for identifying a surveillance target person determined as a missing person. In addition, the warning information may further include a length of time during which a surveillance target person is missing. Further, the warning information may further include a place and a time where and when the missing person is detected most recently.

Hereinafter, a modification example of the image processing apparatus 10 according to the present example embodiment is described. At least one of a whitelist and a blacklist is generated in advance, and is stored in a storage apparatus of the image processing apparatus 10. A feature value (such as face information) of an external appearance of a person who is allowed to be in a facility is registered in the whitelist. A feature value (such as face information) of an external appearance of a person who is not allowed to be in the facility is registered in the blacklist.

Further, the search unit 13 performs at least either of “processing of searching for, within a camera image, a person who is not registered in the whitelist”, and “processing of searching for, within a camera image, a person who is registered in the blacklist”. Further, in a case where either of “detecting, within a camera image, a person who is not registered in the whitelist”, and “detecting, within a camera image, a person who is registered in the blacklist” is satisfied, the search unit 13 outputs warning information. For example, it is possible to display warning information on a display installed in the facility, output a warning sound via a speaker installed in the facility, or turn on a warning lamp installed in the facility.

The warning information to be output indicates “detecting, within a camera image, a person who is not registered in the whitelist”, or “detecting, within a camera image, a person who is registered in the blacklist”. Further, the warning information to be output may further indicate at least one of a captured image, a detected time, and a detected place of a detected person.

Other configurations of the image processing apparatus 10 according to the present example embodiment are similar to the configurations of the image processing apparatus 10 according to the first to fourth example embodiments.

In the image processing apparatus 10 according to the present example embodiment, an advantageous effect similar to that of the image processing apparatus 10 according to the first to fourth example embodiments is achieved. Further, the image processing apparatus 10 according to the present example embodiment can determine a missing person, and detect a suspicious person (a person who is not registered in the whitelist, or a person who is registered in the blacklist), based on a search result by the search unit 13. Consequently, a safety level of the facility improves.

### Sixth Example Embodiment

An image processing apparatus 10 according to a present example embodiment includes a function of generating, based on a search result by a search unit 13, a behavior report indicating a behavior content of each of surveillance target persons in a day, or material information for generating the behavior report. Hereinafter, details are described.

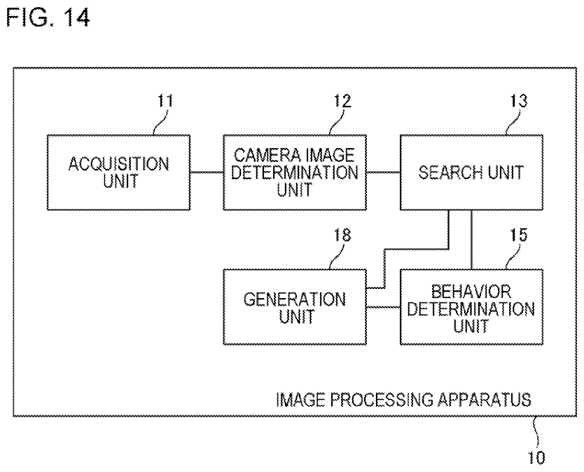

FIG. 14 illustrates one example of a functional block diagram of the image processing apparatus 10. As illustrated in FIG. 14, the image processing apparatus 10 includes an acquisition unit 11, a camera image determination unit 12, the search unit 13, a behavior determination unit 15, and a generation unit 18. Although not illustrated, the image processing apparatus 10 may further include at least one of an image providing unit 14, an image selection unit 16, and a missing person determination unit 17.

The generation unit 18 generates a behavior report (electronic data) indicating a behavior content of each of surveillance target persons in a day, based on behavior history information generated by the behavior determination unit 15. The generated behavior report is output via any output apparatus such as a display, a printer, or a projection apparatus. Further, the generated behavior report may be stored in a storage apparatus of the image processing apparatus 10, or transmitted to an external apparatus (apparatus utilized by a parent or a relative). The behavior history information generated by the behavior determination unit 15 is as described in the fourth example embodiment.

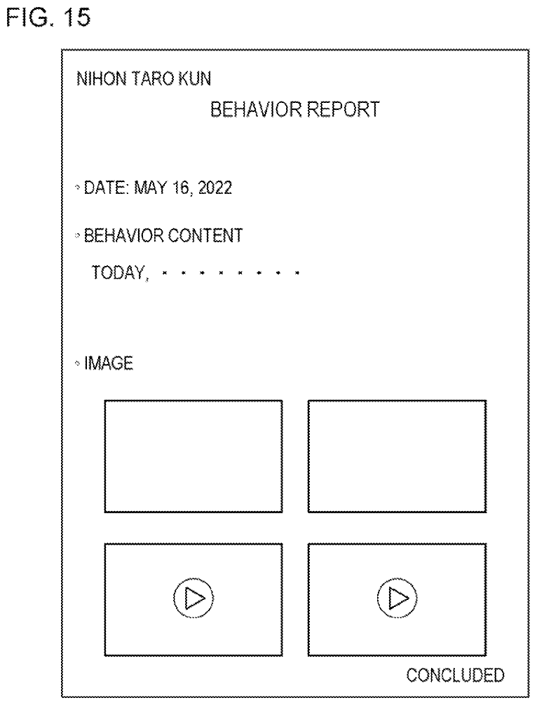

FIG. 15 illustrates one example of a behavior report. As illustrated in FIG. 15, the behavior report includes items on a date, a behavior content, and an image (concept including a still image and a moving image).

In the item on the behavior content, a behavior content in the day is indicated by a text. For example, the generation unit 18 can generate a text on a behavior content by embedding, in a sentence template being prepared in advance, information included in the behavior history information as illustrated in FIG. 10. An example of the template sentence is, for example, “made (a behavior content) at (a time)” and the like. Further, the generation unit 18 may write, in the item on the behavior content, a comment (see FIG. 11) registered by a worker.

In the item on the image, some of camera images in which each of surveillance target persons searched by the search unit 13 is captured are displayed. For example, a camera image selected by the image selection unit 16 described in the fifth example embodiment may be displayed.

Note that, as a modification example, the generation unit 18 may generate material information for generating a behavior report, in place of the behavior report. The material information includes at least one of “a camera image in which each of surveillance target persons searched by the search unit 13 is captured”, “a camera image selected by the image selection unit 16 described in the fifth example embodiment”, “behavior history information”, and “a registered comment”. The generated material information is output via any output apparatus such as a display, a printer, or a projection apparatus. In a case of this example, a worker in a facility generates a behavior report, based on output material information.

Other configurations of the image processing apparatus 10 according to the present example embodiment are similar to the configurations of the image processing apparatus 10 according to the first to fifth example embodiments.

In the image processing apparatus 10 according to the present example embodiment, an advantageous effect similar to that of the image processing apparatus 10 according to the first to fifth example embodiments is achieved. Further, in the image processing apparatus 10 according to the present example embodiment, it is possible to generate and output a behavior report indicating a behavior content of each of surveillance target persons in a day, and material information for generating the behavior report. By the function, labor of a worker in a facility is reduced.

As described above, while the example embodiments according to the present invention have been described with reference to the drawings, these are an example of the present invention, and various configurations other than the above can also be adopted. Configurations of the above-described example embodiments may be combined with each other, or some of the configurations may be replaced by another configuration. Further, various modifications may be added to a configuration of the above-described example embodiments within a range that does not depart from the gist. Furthermore, a configuration and processing disclosed in the above-described example embodiments and modification examples may be combined with each other.

Further, in a plurality of flowcharts used in the above description, a plurality of processes (pieces of processing) are described in order, but an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.
1. An image processing apparatus including:
   an acquisition unit that acquires a plurality of camera images photographed by a plurality of cameras installed within a facility;
   a camera image determination unit that determines, based on at least one of weather information on a day, schedule information of each surveillance target person on the day, and a behavior tendency of each surveillance target person within a facility, the camera image for which each of the surveillance target persons is searched from among a plurality of the camera images; and
   a search unit that searches for each of the surveillance target persons from among each of the camera images being determined as a target for which each of the surveillance target persons is searched.
2. The image processing apparatus according to supplementary note 1, further including
   an image providing unit that determines, based on a result of the search, the camera being presumed to be photographing the specified surveillance target person, and transmits, to an external apparatus, the camera image photographed by the determined camera.
3. The image processing apparatus according to supplementary note 1 or 2, further including
   an image providing unit that determines, based on a result of the search, the camera being presumed to be photographing the specified surveillance target person, in a case where a plurality of the cameras are determined, outputs candidate information indicating the determined plurality of the cameras, accepts an input of specifying one from among the determined plurality of the cameras, and transmits, to an external apparatus, the camera image photographed by the specified camera.
4. The image processing apparatus according to supplementary note 3, wherein,
   in a case where the plurality of the cameras are determined, ranking of ranking display in the candidate information is performed, based on a size of the surveillance target person within the camera image.
5. The image processing apparatus according to any one of supplementary notes 1 to 4, further including:
   a behavior determination unit that determines, based on a result of the search, behavior made by each of the surveillance target persons, and generates behavior history information; and
   an image selection unit that selects, based on the behavior history information, the camera image that satisfies a predetermined condition for the each surveillance target person.
6. The image processing apparatus according to supplementary note 5, wherein
   the behavior history information indicates a content of behavior, and a behavior execution time, and
   the image selection unit selects the camera image photographed at a timing when predetermined behavior is made.
7. The image processing apparatus according to any one of supplementary notes 1 to 6, further including
   a missing person determination unit that determines, based on a result of the search, the surveillance target person whose state in which the surveillance target person is not photographed by any of the cameras is continued for a predetermined time or longer.
8. The image processing apparatus according to any one of supplementary notes 1 to 7, further including:
   a behavior determination unit that determines, based on a result of the search, behavior made by each of the surveillance target persons, and generates behavior history information; and
   a generation unit that generates, based on the behavior history information, a behavior report indicating a behavior content of each of the surveillance target persons in a day, or material information for generating the behavior report, wherein
   the behavior report includes a text, and the surveillance camera image.
9. An image processing method including,
   by a computer:
   acquiring a plurality of camera images photographed by a plurality of cameras installed within a facility;
   determining, based on at least one of weather information on a day, schedule information of each surveillance target person on the day, and a behavior tendency of each surveillance target person within a facility, the camera image for which each of the surveillance target persons is searched from among a plurality of the camera images; and
   searching for each of the surveillance target persons from among each of the camera images being determined as a target for which each of the surveillance target persons is searched.
10. A program causing a computer to function as:
   an acquisition unit that acquires a plurality of camera images photographed by a plurality of cameras installed within a facility;
   a camera image determination unit that determines, based on at least one of weather information on a day, schedule information of each surveillance target person on the day, and a behavior tendency of each surveillance target person within a facility, the camera image for which each of the surveillance target persons is searched from among a plurality of the camera images; and
   a search unit that searches for each of the surveillance target persons from among each of the camera images being determined as a target for which each of the surveillance target persons is searched.
10 Image processing apparatus
11 Acquisition unit
12 Camera image determination unit
13 Search unit
14 Image providing unit
15 Behavior determination unit
16 Image selection unit
17 Missing person determination unit
18 Generation unit
1A Processor
2A Memory
3A Input/output I/F
4A Peripheral circuit
5A Bus

1. An image processing apparatus comprising:
at least one memory configured to store one or more instructions; and
at least one processor configured to execute the one or more instructions to:
acquire a plurality of camera images photographed by a plurality of cameras installed within a facility;
determine, based on at least one of weather information on a day, schedule information of each surveillance target person on the day, and a behavior tendency of each surveillance target person within a facility, the camera image for which each of the surveillance target persons is searched from among a plurality of the camera images; and
search for each of the surveillance target persons from among each of the camera images being determined as a target for which each of the surveillance target persons is searched.

2. The image processing apparatus according to claim 1,
wherein the processor is further configured to execute the one or more instructions to determine, based on a result of the search, the camera being presumed to be photographing the specified surveillance target person, and transmit, to an external apparatus, the camera image photographed by the determined camera.

3. The image processing apparatus according to claim 1,
wherein the processor is further configured to execute the one or more instructions to determine, based on a result of the search, the camera being presumed to be photographing the specified surveillance target person, in a case where a plurality of the cameras are determined, output candidate information indicating the determined plurality of the cameras, accept an input of specifying one from among the determined plurality of the cameras, and transmit, to an external apparatus, the camera image photographed by the specified camera.

4. The image processing apparatus according to claim 3,
wherein the processor is further configured to execute the one or more instructions to rank of ranking display in the candidate information is performed, based on a size of the surveillance target person within the camera image, in a case where the plurality of the cameras are determined.

5. The image processing apparatus according to claim 1,
wherein the processor is further configured to execute the one or more instructions to:
determine, based on a result of the search, behavior made by each of the surveillance target persons, and generate behavior history information; and
select, based on the behavior history information, the camera image that satisfies a predetermined condition for the each surveillance target person.

6. The image processing apparatus according to claim 5,
wherein the behavior history information indicates a content of behavior, and a behavior execution time, and
wherein the processor is further configured to execute the one or more instructions to select the camera image photographed at a timing when predetermined behavior is made.

7. The image processing apparatus according to claim 1,
wherein the processor is further configured to execute the one or more instructions to determine, based on a result of the search, the surveillance target person whose state in which the surveillance target person is not photographed by any of the cameras is continued for a predetermined time or longer.

8. The image processing apparatus according to claim 1,
wherein the processor is further configured to execute the one or more instructions to:
determine, based on a result of the search, behavior made by each of the surveillance target persons, and generate behavior history information; and
generate, based on the behavior history information, a behavior report indicating a behavior content of each of the surveillance target persons in a day, or material information for generating the behavior report, wherein
the behavior report includes a text, and the surveillance camera image.

9. An image processing method comprising,
by a computer:
acquiring a plurality of camera images photographed by a plurality of cameras installed within a facility;
determining, based on at least one of weather information on a day, schedule information of each surveillance target person on the day, and a behavior tendency of each surveillance target person within a facility, the camera image for which each of the surveillance target persons is searched from among a plurality of the camera images; and
searching for each of the surveillance target persons from among each of the camera images being determined as a target for which each of the surveillance target persons is searched.

10. The image processing method according to claim 9, further comprising,
determining, based on a result of the search, the camera being presumed to be photographing the specified surveillance target person, and transmitting, to an external apparatus, the camera image photographed by the determined camera.

11. The image processing method according to claim 9, further comprising,
determining, based on a result of the search, the camera being presumed to be photographing the specified surveillance target person, in a case where a plurality of the cameras are determined, outputting candidate information indicating the determined plurality of the cameras, accepting an input of specifying one from among the determined plurality of the cameras, and transmitting, to an external apparatus, the camera image photographed by the specified camera.

12. The image processing method according to claim 11, further comprising,
ranking of ranking display in the candidate information is performed, based on a size of the surveillance target person within the camera image, in a case where the plurality of the cameras are determined.

13. The image processing method according to claim 9, further comprising,
determining, based on a result of the search, behavior made by each of the surveillance target persons, and generating behavior history information; and
selecting, based on the behavior history information, the camera image that satisfies a predetermined condition for the each surveillance target person.

14. The image processing method according to claim 13,
wherein the behavior history information indicates a content of behavior, and a behavior execution time, and
wherein selecting the camera image photographed at a timing when predetermined behavior is made.

15. A non-transitory storage medium storing a program causing a computer to:
acquire a plurality of camera images photographed by a plurality of cameras installed within a facility;
determine, based on at least one of weather information on a day, schedule information of each surveillance target person on the day, and a behavior tendency of each surveillance target person within a facility, the camera image for which each of the surveillance target persons is searched from among a plurality of the camera images; and
search for each of the surveillance target persons from among each of the camera images being determined as a target for which each of the surveillance target persons is searched.

16. The non-transitory storage medium according to claim 15,
wherein the program causing the computer to determine, based on a result of the search, the camera being presumed to be photographing the specified surveillance target person, and transmit, to an external apparatus, the camera image photographed by the determined camera.

17. The non-transitory storage medium according to claim 15,
wherein the program causing the computer to determine, based on a result of the search, the camera being presumed to be photographing the specified surveillance target person, in a case where a plurality of the cameras are determined, output candidate information indicating the determined plurality of the cameras, accept an input of specifying one from among the determined plurality of the cameras, and transmit, to an external apparatus, the camera image photographed by the specified camera.

18. The non-transitory storage medium according to claim 17,
wherein the program causing the computer to rank of ranking display in the candidate information is performed, based on a size of the surveillance target person within the camera image, in a case where the plurality of the cameras are determined.

19. The non-transitory storage medium according to claim 15,
wherein the program causing the computer to:
determine, based on a result of the search, behavior made by each of the surveillance target persons, and generate behavior history information; and
select, based on the behavior history information, the camera image that satisfies a predetermined condition for the each surveillance target person.

20. The non-transitory storage medium according to claim 19,
wherein the behavior history information indicates a content of behavior, and a behavior execution time, and
wherein the program causing the computer to select the camera image photographed at a timing when predetermined behavior is made.
